(19) United States
(12) Patent Application Publication
(10) Pub. No.: US 2026/0118856 A1
(43) Pub. Date: Apr. 30, 2026

(54) GENERATING INFORMATION IN REAL-TIME DURING MODIFICATIONS TO RENDERED PRODUCT ASSEMBLIES

(71) Applicant: AUTODESK, INC., San Francisco, CA (US)

(72) Inventors: Mohammadmehdi ATAEI, Toronto (CA); Hyunmin CHEONG, Toronto (CA); Justin Frank MATEJKA, Newmarket (CA); George William FITZMAURICE, Toronto (CA); Alexander TESSIER, Toronto (CA)

(21) Appl. No.: 19/274,294

(22) Filed: Jul. 18, 2025

Related U.S. Application Data
(60) Provisional application No. 63/713,039, filed on Oct. 28, 2024.

(51) Int. Cl. G05B 19/418

(52) U.S. Cl. CPC G05B 19/41865; G05B 2219/31376; G05B 2219/35209

(57) ABSTRACT

One embodiment sets forth a computer-implemented method for performing operations associated with modifying product assemblies. The computer-implemented method includes receiving a request for modifying a rendered product assembly; performing, in response to the request, at least one modification to the rendered product assembly; concurrently displaying a modified product assembly that reflects the at least one modification to the rendered product assembly; and concurrently updating a graphic display of one or more attributes of one or more components of the modified product assembly to enable evaluation of an effect of the at least one modification to the rendered product assembly.

### CROSS-REFERENCE TO RELATED APPLICATIONS

The present application claims the benefit of U.S. Provisional Application titled, “TECHNIQUES FOR REAL-TIME ASSEMBLY DESIGN GENERATION USING GENERATIVE ARTIFICIAL INTELLIGENCE BASED ON REQUIREMENT CHANGES,” filed on Oct. 28, 2024, and having Ser. No. 63/713,039. The subject matter of this related application is hereby incorporated herein by reference.

### BACKGROUND

### Field of the Various Embodiments

Embodiments of the present disclosure relate generally to performing modifications on product assemblies, and more specifically to automatically generating information in real-time when performing modifications to rendered product assemblies.

### Description of the Related Art

In many digital design and manufacturing environments, product assemblies are represented and manipulated using computer-aided design (CAD) tools. Such tools allow operators to view rendered versions of complex assemblies and make modifications such as replacing individual components, resizing or repositioning parts, or removing and adding elements entirely. Each modification to the rendered product assembly may have implications for related downstream documentation, including specifications, diagrams, and a bill of materials (BOM). Accurate generation of such documentation is important to ensure alignment between the digital representation and the physical production of the product assembly. In practice, operators are often required to update the BOM and other documentation manually to reflect each modification made to the digital model.

A traditional approach for maintaining accurate documentation in the face of ongoing modifications involves generating and saving multiple versions of the BOM-one corresponding to each revision of the product assembly. For example, after performing a first modification to an existing product assembly, a first BOM may be generated and saved with a descriptive label. A second modification may prompt generation of a second BOM, also saved with a unique label, and the process may be repeated for any number of subsequent revisions. The operator is ultimately responsible for determining which version of the BOM reflects the final product assembly and for discarding earlier BOMs that no longer correspond to the current design.

One drawback of the foregoing approach is that the foregoing approach requires manual and meticulous effort by the CAD operator to generate a new BOM after each revision, assign a distinct and traceable label to each BOM, and track the relationship between individual revisions and the corresponding BOMs. Such a process can become increasingly complex and error-prone as the number of revisions grows, particularly in collaborative or fast-paced design environments. Additionally, inaccurate or incomplete labeling, premature deletion of intermediate BOMs, or failure to capture all changes in a given version can lead to discrepancies between the final BOM and the actual design. Such discrepancies may result in costly manufacturing errors, delays in production, or inconsistencies in the supporting documentation. Moreover, the foregoing approach requires the operator to have sufficient expertise in managing the processes efficiently and without oversight, which may not always be possible or practical.

As the foregoing illustrates, what is needed in the art is an alternative to traditional operations associated with modifying product assemblies and generating associated documents.

### SUMMARY

One embodiment sets forth a computer-implemented method for performing operations associated with modifying product assemblies. According to some embodiments, the method includes the steps of receiving a request for modifying a rendered product assembly; performing, in response to the request, at least one modification to the rendered product assembly; concurrently displaying a modified product assembly that reflects the at least one modification to the rendered product assembly; and concurrently updating a graphic display of one or more attributes of one or more components of the modified product assembly to enable evaluation of an effect of the at least one modification to the rendered product assembly.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques over the prior art is that, by leveraging artificial intelligence (AI) systems, the disclosed techniques enable efficient and accurate modification of product assemblies while simultaneously generating real-time information associated with each modification. Such information may include a rendering of the modified assembly, a bill of materials (BOM), a specification sheet, a preferred list of components, and data reflecting component cost, availability, and placement. Real-time graphical displays of various metrics and attributes allow for continuous evaluation and refinement of the modified assembly based on design parameters such as performance or cost. The use of AI improves the quality and accuracy of results, reduces the likelihood of manual errors, and enhances processing efficiency by automating complex update operations. In contrast to traditional non-AI techniques, which typically produce a single design output for each modification, the disclosed techniques can generate multiple candidate variations in response to a single modification input. Such generative capability allows for broader exploration of the design space—far beyond what could be feasibly achieved through manual methods—and supports optimization processes that converge on higher-quality and better-performing design solutions.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a real-time modification system for modifying a rendered product assembly and generating information in real time, in accordance with various embodiments.

FIG. 2 illustrates a first example embodiment of the real-time modification system shown in FIG. 1, in accordance with various embodiments.

FIG. 3 illustrates a second example embodiment of the real-time modification system shown in FIG. 1, in accordance with various embodiments.

FIG. 4 shows an example graphic display of information associated with modification to a rendered product assembly, in accordance with various embodiments.

FIG. 5 shows an example graphic display of guidance instructions for use of various components by an AI system for modifying a product assembly, in accordance with various embodiments.

FIG. 6 shows an example graphic display of a bill of materials (BOM) that is automatically generated by an AI system, in accordance with various embodiments.

FIG. 7 shows an example flowchart of a method for modifying a product assembly, in accordance with various embodiments.

FIG. 8 is a detailed illustration of a computing device that can implement the functionalities of the various entities, in accordance with various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

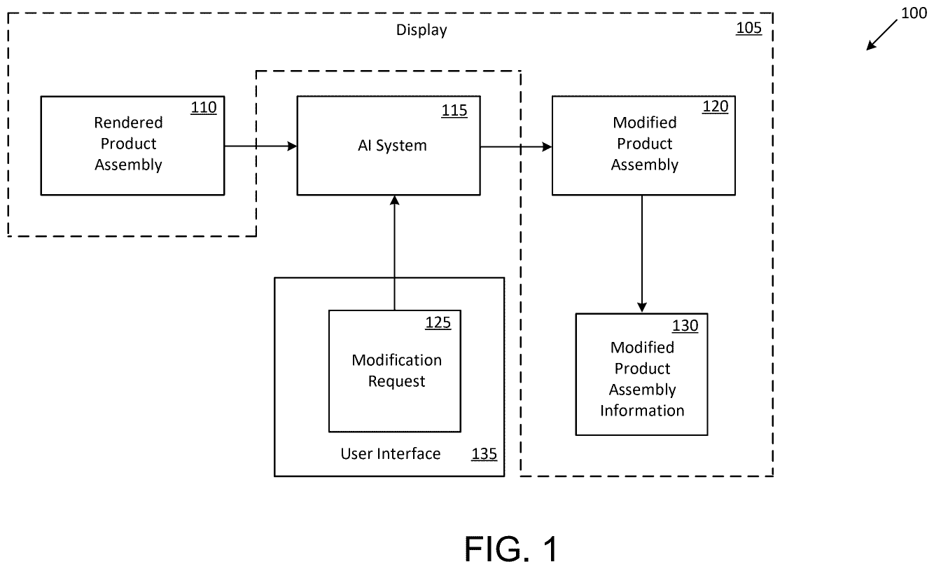

FIG. 1 illustrates a real-time modification system 100 for modifying a rendered product assembly and generating information in real time, in accordance with various embodiments. The functional representation of the real-time modification system 100 includes a rendered product assembly 110 that can be displayed on a display 105 to allow a user to see a 3D graphical rendering of an object. An example scenario involves the object as a combination of interlinked parts such as a system comprised of intermeshed gears. Another example scenario involves the object as a combination of interlinked parts such as a machine, a vehicle, a toy, a piece of furniture, or a building. In some cases, the parts can be fixed with respect to each other, and in other cases, two or more parts can move with respect to each other.

The real-time modification system 100 further includes a user interface 135 that can incorporate items such as a keyboard, a mouse, a joystick, a microphone, a scanner, a camera, a touchpad, a trackpad, a sketchpad, a drawing tablet, and/or a paper tablet. The user interface 135 serves as an interaction medium with an artificial intelligence (AI) system 115 configured to generate a modified product assembly 120 in response to a modification request 125 submitted to the AI system 115 by a user of the user interface 135. In an example scenario, the modification request 125 aims at modifying and/or updating the rendered product assembly 110 to enhance or improve the rendered product assembly 110.

In an example procedure, the user places a cursor upon the rendered product assembly 110 and operates a mouse to execute various operations, such as moving a component of the rendered product assembly 110 from one location to another, deleting a component, adding a component, re-orienting, or re-sizing a component. In another example implementation, the user provides the request via the user interface 135 in the form of a hand-drawn sketch, a segment of text, an audio clip, and/or a video clip.

The AI system 115 responds to the modification request 125 by generating the modified product assembly 120 and concurrently generating modified product assembly information 130. Concurrent generation of the modified product assembly information 130 permits the user of the user interface 135 to carry out certain operations in real-time based on actions such as evaluating the modified product assembly 120, evaluating the modified product assembly information 130, and/or comparing the modified product assembly 120 to the rendered product assembly 110.

Thus, in one case, the user may observe the modified product assembly information 130, and upon finding a first modification, such as re-sizing a component, unsatisfactory, the user may perform a second modification in real-time to alter the component size more to the user's satisfaction.

In another case, the user may make a modification request 125 involving the addition of a component to the rendered product assembly 110. In an example scenario, the AI system 115 responds to the modification request 125 by not merely adding the component to the rendered product assembly 110 in a one-to-one manner but by offering various options that include modifying other components affected by the additional component. Another example scenario involves the resulting modified product assembly information 130 generated by the AI system 115 providing a real-time indication to the user that the component is unsuitable or incompatible for addition due to factors such as size, cost, availability, or other issues. The user can cancel the addition request based on the indication.

Actions such as the example actions described above that can be performed in accordance with the various embodiments described herein provide various technical advantages over prior art approaches where a user modifies a product assembly and generates associated documentation sequentially. In at least some traditional cases, the associated documentation, such as a bill of materials, is unsuitable for the user to obtain feedback about a desired modification. Even when suitable, a time delay involved in sequentially generating the associated documentation after completing the modification makes the traditional process time-consuming and inefficient compared to the real-time operations supported by the real-time modification system 100.

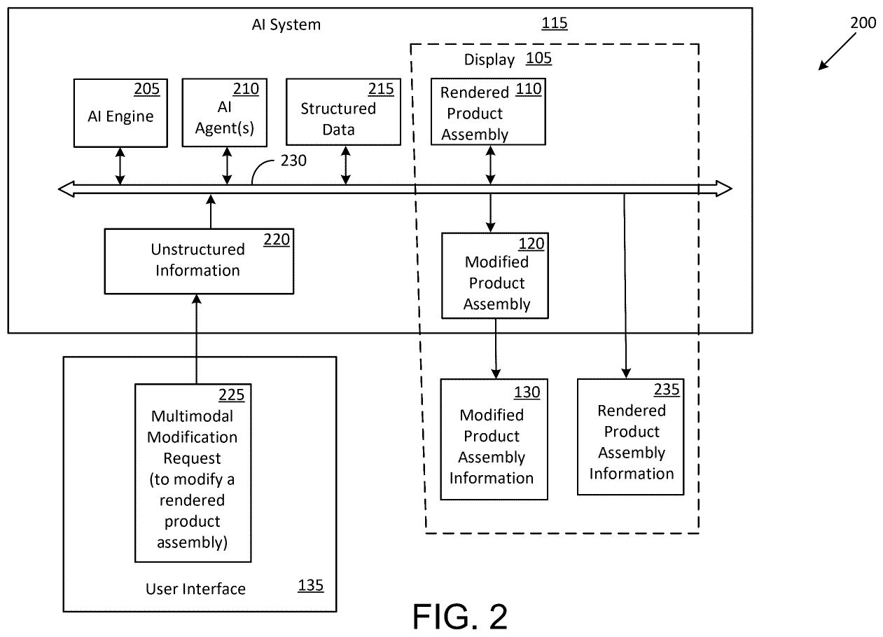

FIG. 2 illustrates a first example embodiment 200 of the real-time modification system 100. This embodiment includes the user interface 135 and the AI system 115. The AI system 115 includes an AI engine 205 and further includes various functional blocks interconnected via a communication bus 230. In this illustrated embodiment, the user interface 135 provides a multimodal modification request 225 to modify the rendered product assembly 110. The multimodal modification request 225 can be in various forms, such as text, images, printed material, audio input, or video input, that can be processed by the AI engine 205 using techniques like large language models (LLMs) and vision language models (VLMs). The AI system 115 uses AI to harness the expertise of various types of domain experts and the richness of information accessible via a network, for example, the Internet.

In one implementation, the AI engine 205 can be an artificial intelligence/machine learning (AI/ML) engine. The AI/ML engine can be based on a generative AI model, a regenerative AI model, a deep learning model, or a linear regression block. The AI/ML engine typically incorporates various types of algorithms and techniques that replicate human intelligence. In another example implementation, the AI/ML engine performs machine learning operations based on information provided in the form of training data. The training data may be generated by historic operations performed by the AI engine 205. In another example implementation, the AI/ML engine performs AI/ML operations that include a combination of AI operations and ML operations.

The multimodal modification request 225 is typically provided in the form of unstructured information 220 that the AI engine 205 converts into structured data 215. Conversion can be accomplished by various AI agents 210, such as AI agents that use pretrained models and configurable AI agents. AI agents that use pretrained models understand, interpret, and act upon various types of information for performing complex tasks and for making decisions autonomously. In some cases, pretrained AI models include neural networks that can be trained on a large number of diverse datasets. Pre-training enables the AI agents to perform tasks such as Natural Language Processing (NLP) and computer vision. Configurable AI agents are autonomous software programs that are designed to perform tasks, make decisions, and interact with different environments based on predefined goals and learned experiences. Unlike traditional AI systems that require explicit programming for every scenario, configurable agents can be customized to specific needs, workflows, and environments, thereby offering a higher degree of flexibility and adaptability. Furthermore, configurable AI agents can function independently and can improve performance over time based on continuously learning from various interactions.

The AI engine 205 can use one or more types of AI agents 210 to generate the modified product assembly 120 based on the structured data 215 and to concurrently generate the modified product assembly information 130. In an example implementation, the AI engine 205 may also generate rendered product assembly information 235.

In this example, the rendered product assembly 110, the rendered product assembly information 235, the modified product assembly 120, and the modified product assembly information 130 can be displayed on the display 105 for viewing by a user of the user interface 135. A user can perform various actions concurrently in real-time, including comparing the modified product assembly 120 to the rendered product assembly 110 and deciding whether the modified product assembly 120 is satisfactory. Based on such decisions, the user can provide additional multimodal modification requests 225 to further modify the rendered product assembly 110.

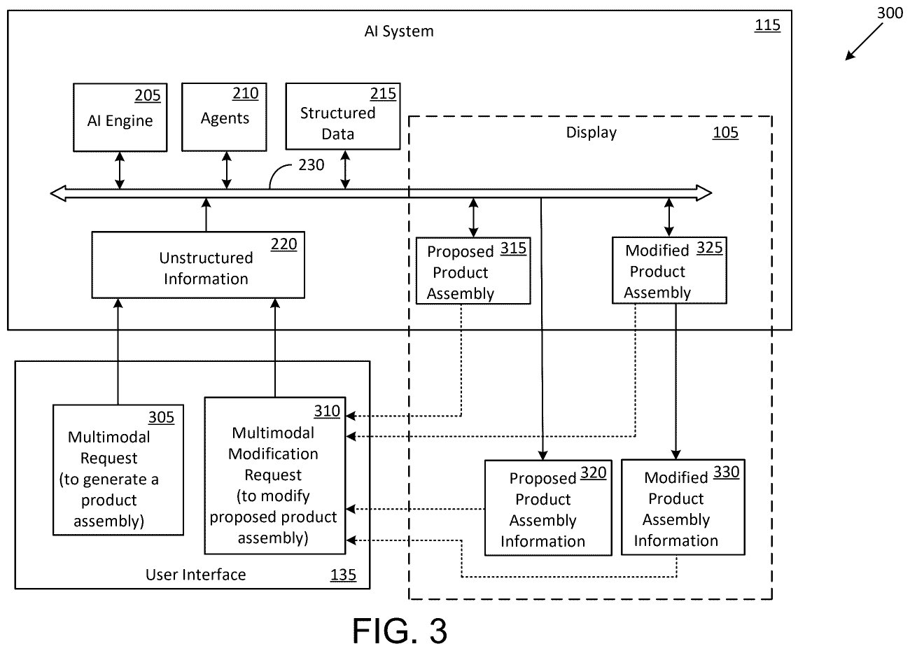

FIG. 3 illustrates a second example embodiment 300 of the real-time modification system 100. This embodiment includes the user interface 135 and the AI system 115. In this illustrated embodiment, the user interface 135 is used to provide a multimodal modification request 305 to the AI system 115 to generate a product assembly using AI techniques. The unstructured information 220 is converted to structured data 215 based on the interpretation of the multimodal modification request 225 by the AI engine 205. The AI engine 205 then generates a proposed product assembly 315 based on the structured data 215, and concurrently generates proposed product assembly information 320.

The proposed product assembly 315 and the proposed product assembly information 320 are displayed on the display 105 for viewing by the user. The user can evaluate the proposed product assembly 315 and/or the proposed product assembly information 320 and decide whether the proposed product assembly 315 meets expectations. If the proposed product assembly 315 satisfies expectations, then the user may use the proposed product assembly 315. If the proposed product assembly 315 fails to meet expectations, then the user can provide a multimodal modification request 310 to modify the proposed product assembly 315. The multimodal modification request 310 can be based on evaluation of the proposed product assembly information 320 by the user. For example, the proposed product assembly information 320 may indicate that one or more components of the proposed product assembly 315 require replacement, deletion, resizing, and/or relocation. The AI engine 205 generates a modified product assembly 325 in response to the multimodal modification request 310 and concurrently generates modified product assembly information 330. The modified product assembly 325 and the modified product assembly information 330 are displayed on the display 105 for user viewing.

In some implementations, the proposed product assembly 315 and the proposed product assembly information 320 may also be displayed along with the modified product assembly 325 and the modified product assembly information 330 to enable the user to obtain a comprehensive view of the modifications performed on the proposed product assembly information 320. In this case, the multimodal modification request 310 can be based on evaluation of the proposed product assembly 315, evaluation of the proposed product assembly information 320, evaluation of the modified product assembly 325, evaluation of the modified product assembly information 330, comparing the modified product assembly 325 to the proposed product assembly 315, and/or comparing the proposed product assembly information 320 to the modified product assembly information 330.

The user can then perform additional actions if dissatisfied with the displayed results. The additional actions can include resubmitting the multimodal request 305 verbatim to request the AI system 115 to generate another version of the proposed product assembly 315, submitting a modified version of the multimodal request 305, resubmitting the multimodal modification request 310 verbatim to request that the AI system 115 generate another version of the modified product assembly 325, or submitting a modified version of the multimodal modification request 310.

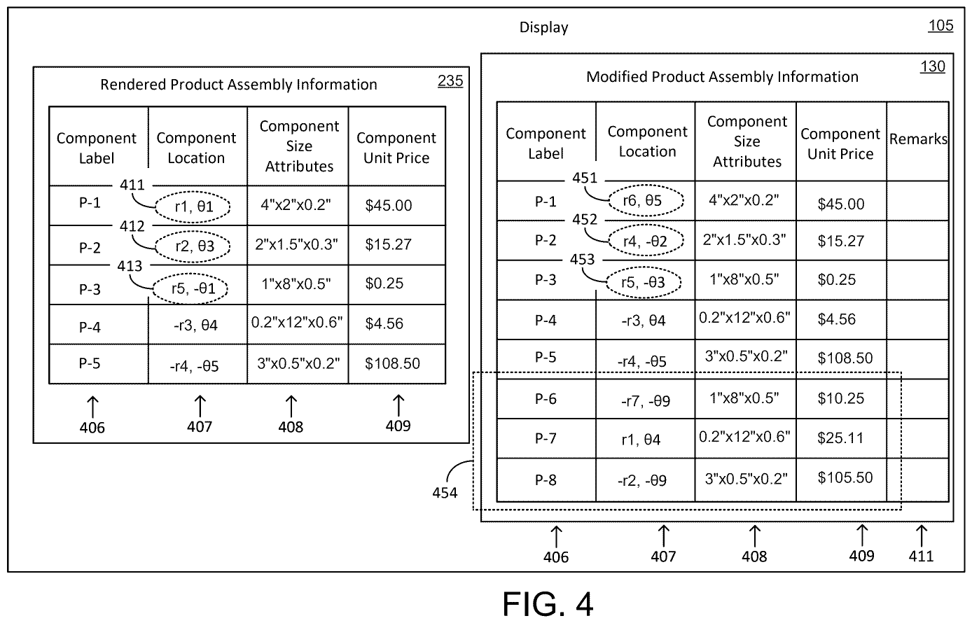

FIG. 4 shows an example graphic display of information associated with modification to a rendered product assembly in accordance with various embodiments. More particularly, in this example, rendered product assembly information 235 and modified product assembly information 130 are shown as real-time graphic displays on the display 105. The illustrated graphic format and content of the rendered product assembly information 235 and modified product assembly information 130 in the form of a table of various metrics and attributes is one of several example graphic formats and contents. In other implementations, some of the columns can provide other types of information, some additional rows and/or columns can be displayed, some rows and/or columns can be omitted, and/or the information can be provided in formats other than a table, such as a pie chart, a bar chart, a histogram, a Venn diagram, a line graph, or a scatter plot.

In this example illustration, the rendered product assembly information 235 can be associated with the rendered product assembly 110 described in FIG. 1 and FIG. 2. In another example implementation, the proposed product assembly information 320 described in FIG. 3 can be displayed in a format substantially identical to the rendered product assembly information 235. The example modified product assembly information 130 is displayed on display 105 in real-time, concurrent with generation of the modified product assembly 120.

The example rendered product assembly information 235 includes several rows and several columns indicating various metrics. Column 406 indicates labels of various components included in the rendered product assembly 110. Column 407 indicates location information for each of the components shown in column 406. Column 408 indicates component size attributes for each of the components shown in Column 406. Column 409 indicates unit price for each of the components shown in Column 406.

Component location information indicated in column 406 is illustrated in the form of location coordinates. In other implementations, component location information can be provided in various other formats. An example location of component “P-1” is shown as (r1, θ1) (dashed line oval 411), an example location of component “P-2” is shown as (r2, θ3) (dashed line oval 412), an example location of component “P-3” is shown as (r5, −θ1) (dashed line oval 413), and so on.

The example modified product assembly information 130 provides information on the modifications performed upon the rendered product assembly 110. In this example implementation, columns 406-409 of the modified product assembly information 130 match the columns of the rendered product assembly information 235. In another example implementation, some columns of the modified product assembly information 130 may not match the columns of the rendered product assembly information 235, some columns may be omitted, and some columns may be added. In the illustrated example, modified product assembly information 130 further includes a “Remarks” column 411 that can display remarks associated with one or more modifications performed upon one or more components such as indicating feasibility, desirability, a positive aspect, or a negative aspect of a modification.

In this example, the modifications include a change in component location of P-1 from location coordinates (r1, θ1) (dashed line oval 411) to location coordinates (r6, θ5) (dashed line oval 451). The location coordinates (r6, θ5) dynamically update in real-time with any modifications performed upon component P-1. Thus, if component P-1 is relocated upon the rendered product assembly 110 in response to a modification request, the location coordinates (r6, θ5) will change correspondingly. The user can see the change in location coordinates (r6, θ5) and evaluate the performed modification. Similarly, a change in component location P-2 (r2, θ3) (dashed line oval 412) is dynamically reflected as (r4, −θ2) (dashed line oval 452), and a change in component location P-3 (r5, −θ1) (dashed line oval 413) is dynamically reflected as (r5, −θ3) (dashed line oval 453).

The modified product assembly information 130 also includes information associated with three additional components P-6, P-7, and P-8 (indicated by dashed line box 454). In one example scenario, the three additional components are based on a user request. In another example scenario, the three additional components are proposed by the AI system 115.

In an example implementation, an additional column 411 can be provided for remarks. In one case, the remarks indicate guidance provided by a user to the AI system 115. In another case, the AI system 115 generates the remarks. An example remark can provide an indication that moving P-1 to a new location causes a restriction upon the movement of P-2. Another example remark can provide an indication that adding P-8 causes an undesirable increase in the price of the modified product assembly 120. Another example remark can provide an indication that adding P-6 is undesirable due to a lack of availability of P-2.

If satisfied with the modifications, the user can proceed with using the modified product assembly 120. If unsatisfied with the modifications, the user can perform additional operations upon the rendered product assembly 110, such as moving and/or reorienting one or more components to other locations while concurrently evaluating the modified product assembly information 130. The display of the modified product assembly information 130 on the display 105 enables the user to dynamically perform modifications based on observing the effects of the modifications in real-time.

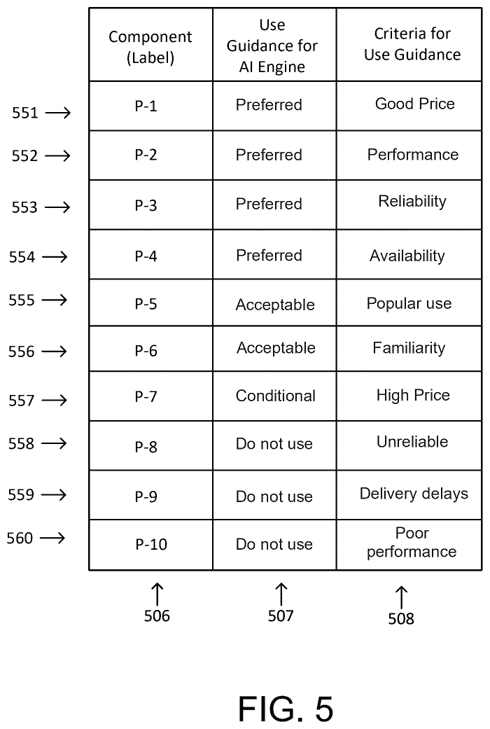

FIG. 5 shows an example graphic display of guidance instructions for the use of various components by the AI system 115 for modifying a product assembly in accordance with various embodiments. In one implementation, the use guidance may be provided to the AI system 115 by a user. In another implementation, the use guidance may be auto-generated by the AI system 115 based on various methods such as historical use, historical information, and/or information obtained from one or more databases accessible by the AI system 115 via a network.

In this example, column 507 indicates use guidance for various components indicated in column 506. Column 508 indicates criteria used for providing the use guidance. More particularly, in this example, row 551 indicates guidance that component P-1 is a preferred component that can be used preferably by the AI engine 205. The use guidance is based on a price criterion of the component P-1. Row 552, row 553, and row 554 indicate similar use guidance for components P-2, P-3, and P-4 based on performance, reliability, and availability criteria respectively.

Row 555 indicates use guidance that component P-5 is an acceptable component that can be used by the AI engine 205. The acceptable use guidance is based on P-5 being used popularly but being less desirable than P-1, for example, concerning price and availability. Row 556 similarly indicates use guidance that component P-6 is an acceptable component that can be used by the AI engine 205. The acceptable use guidance is based on P-6 being familiar but less desirable than P-1, for example, concerning price and availability.

Row 557 indicates use guidance that component P-7 is to be used conditionally by the AI engine 205. The conditional use guidance is based on P-7 having a high price.

Rows 558, 559, and 560 indicate that components P-8, P-9, and P-10 should not be used by the AI engine, even if the user wants to use such components. The do-not-use guidance for components P-8, P-9, and P-10 is based on P-8 being unreliable, P-9 suffering from delivery delays, and P-10 suffering from poor performance.

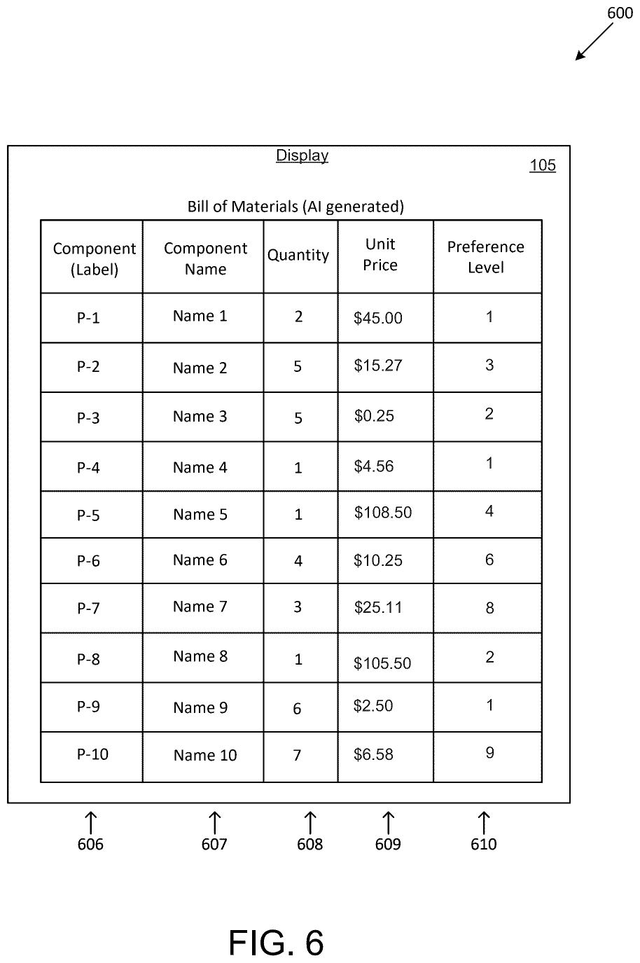

FIG. 6 shows an example bill of materials (BOM) 600 that is automatically generated by the AI engine 205 in accordance with various embodiments. More particularly, BOM 600 is automatically generated by the AI engine 205 concurrently in real-time when generating each instance of a modified product assembly, such as modified product assembly 120 or modified product assembly 325. Generating a unique BOM 600 for each of multiple modified product assemblies provides various technical advantages over traditional practice where typically a single BOM is generated after a modified product assembly is finalized, sometimes after multiple preliminary generation attempts. The traditionally generated BOM, which in many cases is generated manually, does not provide BOM information associated with preliminary generation attempts. In contrast, historical information provided by BOM 600 can be used for various purposes such as reverting to a previous version of a product assembly based on evaluation of various factors such as costs, component availability, and/or evolving design requirements. Furthermore, the real-time generation of the BOM enables a user to evaluate parameters of a modified product assembly that may not be available or readily discernible from a graphical rendering of the modified product assembly.

BOM 600 includes several example columns and rows. Column 606 indicates component labels, column 607 indicates component names, column 608 indicates component quantities, column 609 indicates component prices, and column 610 indicates preference levels. The preference level information can be provided in various ways, such as by using labels like those described with reference to column 508 of the graphic list of guidance instructions. In the illustrated BOM 600, the preference level is indicated by a numerical scale where a larger number indicates a higher preference. In another implementation, preference level information is provided in the form of a ranking. The ranking can be specified by labels, numerals, and/or symbols.

In an example implementation, information shown in column 609 and/or column 610 can be used by a user to determine whether to include or omit a component from a further revision of a modified product assembly. BOM 600 can further be used in traditional ways such as to catalog components, procure components, and create an inventory.

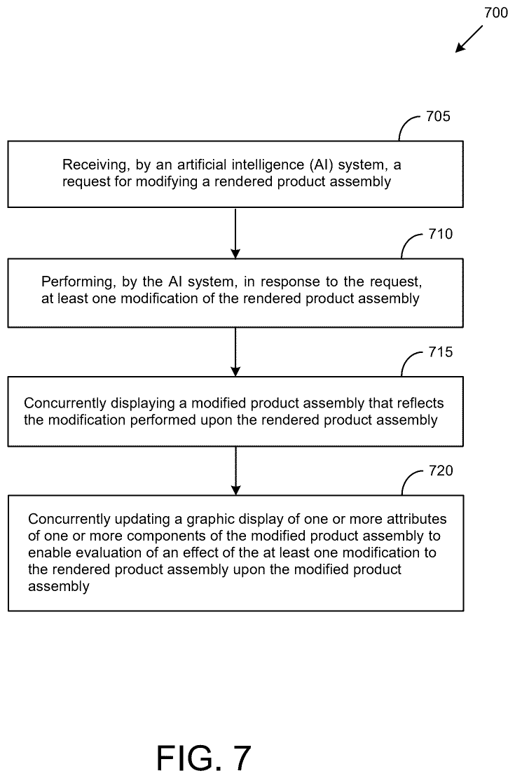

FIG. 7 shows an example flowchart 700 of a method for modifying a product assembly in accordance with various embodiments. At step 705, an AI system such as the AI system 115 described herein receives a request for modifying a rendered product assembly. An example request in the form of a multimodal request 225 is described with reference to FIG. 2. Another example request in the form of a multimodal modification request 310 is described with reference to FIG. 3. In an example execution of step 705, a user places a cursor upon the rendered product assembly and operates a mouse to execute various operations such as moving a component of the rendered product assembly from one location to another, deleting a component, adding a component, re-orienting, or resizing a component. In another example execution of step 705, the user provides the request via a user interface 135, in the form of a hand-drawn sketch, a segment of text, an audio clip, and/or a video clip.

At step 710, the AI system performs at least one modification to the rendered product assembly in response to the request. At step 715, the AI system concurrently displays a modified product assembly performed upon the rendered product assembly. The modified product assembly is displayed by the AI system at substantially the same time as when a modification is performed by the AI system upon the modified product assembly. The real-time display action enables a user to evaluate modifications to decide if each modification is satisfactory. If any modification is deemed unsatisfactory, a remedial modification can be performed in real-time. At step 720, the AI system concurrently updates a graphic display of one or more attributes of one or more components of the modified product assembly to enable evaluation of an effect of the modification to the rendered product assembly.

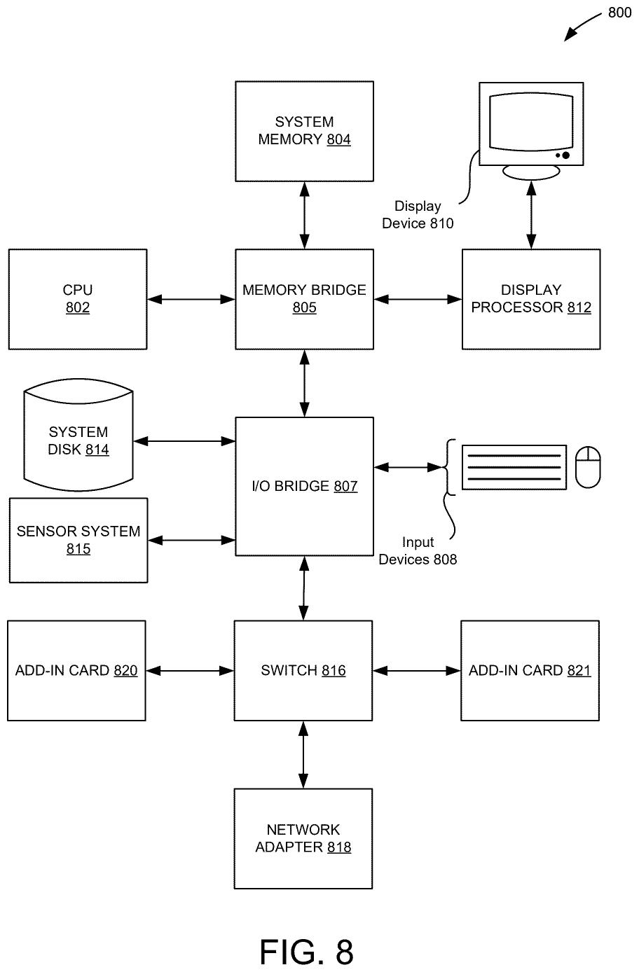

FIG. 8 is an illustration of a computing system 800 that can implement the functionalities of the entities illustrated in FIGS. 1-3, according to various embodiments. This figure in no way limits or is intended to limit the scope of the various embodiments. In various implementations, system 800 may be an augmented reality, virtual reality, or mixed reality system or device, a personal computer, video game console, personal digital assistant, mobile phone, mobile device, or any other device suitable for practicing the various embodiments. Further, in various embodiments, any combination of two or more systems 800 may be coupled together to practice one or more aspects of various embodiments.

As shown, system 800 includes a central processing unit (CPU) 802 and a system memory 804 communicating via a bus path that may include a memory bridge 805. CPU 802 includes one or more processing cores, and CPU 802 is the master processor of system 800, controlling and coordinating operations of other system components. System memory 804 stores software applications and data for use by CPU 802. CPU 802 runs software applications and optionally an operating system. Memory bridge 805, which may be a Northbridge chip, is connected via a bus or other communication path (e.g., a HyperTransport link) to an I/O (input/output) bridge 807. I/O bridge 807, which may be a Southbridge chip, receives user input from one or more user input devices 808 (e.g., keyboard, mouse, joystick, digitizer tablets, touch pads, touch screens, still or video cameras, motion sensors, and/or microphones) and forwards the input to CPU 802 via memory bridge 805.

A display processor 812 is coupled to memory bridge 805 via a bus or other communication path (e.g., a PCI Express, Accelerated Graphics Port, or HyperTransport link); in one embodiment display processor 812 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 804.

Display processor 812 periodically delivers pixels to a display device 810 (e.g., a screen or conventional CRT, plasma, OLED, SED, or LCD-based monitor or television). Additionally, display processor 812 may output pixels to film recorders adapted to reproduce computer-generated images on photographic film. Display processor 812 can provide display device 810 with an analog or digital signal. In various embodiments, one or more of the various graphical user interfaces such as, for example, the user interface 135 illustrated in FIG. 3, are displayed to one or more users via display device 810. Users can input data into and receive visual output from those various graphical user interfaces.

A system disk 814 is also connected to I/O bridge 807 and may be configured to store content, applications, and data for use by CPU 802 and display processor 812. System disk 814 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 816 provides connections between I/O bridge 807 and other components such as a network adapter 818 and various add-in cards 820 and 821. Network adapter 818 allows system 800 to communicate with other systems via an electronic communications network, and may include wired or wireless communication over local area networks and wide area networks such as the Internet.

Other components (not shown), including USB or other port connections, film recording devices, and the like, may also be connected to I/O bridge 807. For example, an audio processor may be used to generate analog or digital audio output from instructions and/or data provided by CPU 802, system memory 804, or system disk 814. Communication paths interconnecting the various components in FIG. 8 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 812 incorporates circuitry optimized for graphics and video processing, including, for example, video output circuitry and constitutes a graphics processing unit (GPU). In another embodiment, display processor 812 incorporates circuitry optimized for general-purpose processing. In yet another embodiment, display processor 812 may be integrated with one or more other system elements, such as the memory bridge 805, CPU 802, and I/O bridge 807 to form a system on chip (SoC). In still further embodiments, display processor 812 is omitted, and software executed by CPU 802 performs the functions of display processor 812.

Pixel data can be provided to display processor 812 directly from CPU 802. In some embodiments, instructions and/or data representing a scene are provided to a render farm or a set of server computers, each similar to system 800, via network adapter 818 or system disk 814. The render farm generates one or more rendered images of the scene using the provided instructions and/or data. These rendered images may be stored on computer-readable media in a digital format and optionally returned to system 800 for display. Similarly, stereo image pairs processed by display processor 812 may be output to other systems for display, stored in system disk 814, or stored on computer-readable media in a digital format.

Alternatively, CPU 802 provides display processor 812 with data and/or instructions defining the desired output images, from which display processor 812 generates the pixel data of one or more output images, including characterizing and/or adjusting the offset between stereo image pairs. The data and/or instructions defining the desired output images can be stored in system memory 804 or graphics memory within display processor 812. Display processor 812 may include 3D rendering capabilities for generating pixel data for output images from instructions and data defining the geometry, lighting shading, texturing, motion, and/or camera parameters for a scene. Display processor 812 can further include one or more programmable execution units capable of executing shader programs, tone mapping programs, and the like.

Further, in other embodiments, CPU 802 or display processor 812 may be replaced with or supplemented by any technically feasible form of processing device configured to process data and execute program code. This processing device could be, for example, a central processing unit (CPU), a graphics processing unit (GPU), an application-specific integrated circuit (ASIC), a field-programmable gate array (FPGA), and so forth. In various embodiments, any of the operations and/or functions described herein can be performed by CPU 802, display processor 812, or one or more other processing devices or any combination of these different processors.

CPU 802, render farm, and/or display processor 812 can employ any surface or volume rendering technique known in the art to create rendered images from the provided data and instructions, including rasterization, scanline rendering, REYES or micropolygon rendering, ray casting, ray tracing, image-based rendering techniques, and/or combinations of these and any other rendering or image processing techniques known in the art.

In other contemplated embodiments, system 800 may be a robot or robotic device and may include CPU 802 and/or other processing units or devices and system memory 804. In such embodiments, system 800 may or may not include other elements shown in FIG. 8. System memory 804 and/or other memory units or devices in system 800 may include instructions that, when executed, cause the robot or robotic device represented by system 800 to execute operations, steps, tasks, or the like.

It will be appreciated that the system shown herein is illustrative and that variations and modifications are possible. The connection topology, including the number and arrangement of bridges, may be modified as desired. For instance, in some embodiments, system memory 804 is connected to CPU 802 directly rather than through a bridge, and other devices communicate with system memory 804 via memory bridge 805 and CPU 802. In other alternative topologies display processor 812 is connected to I/O bridge 807 or directly to CPU 802, rather than to memory bridge 805. In still other embodiments, I/O bridge 807 and memory bridge 805 might be integrated into a single chip. The particular components shown herein are optional; for instance, any number of add-in cards or peripheral devices might be supported. In some embodiments, switch 816 is eliminated, and network adapter 818 and add-in cards 820, 821 connect directly to I/O bridge 807.

In sum, the disclosed techniques set forth a system and method for performing operations associated with modifying product assemblies. In an example procedure according to some embodiments, a user provides a multimodal modification request for modifying an existing product assembly. The multimodal modification request can be provided in any of various forms, such as text, images, printed material, audio input, and/or video input. The multimodal modification request is processed by an artificial intelligence (AI) system by using techniques such as large language models (LLMs) and vision language models (VLMs). Modifying the existing product assembly can include moving a component of the product assembly from one location to another location, deleting a component of the product assembly, adding a component to the product assembly, re-orienting a component of the product assembly, and/or re-sizing a component of the product assembly. The AI system generates a modified product assembly and concurrently generates product assembly information associated with the modified product assembly. Concurrent generation of the product assembly information along with the generation of the modified product assembly, allows the user to perform certain operations such as evaluating the modification of the product assembly in real-time, evaluating the modified product assembly information in real-time, and/or comparing the modified product assembly to the existing product assembly in real-time.

At least one technical advantage of the disclosed techniques over the prior art is that, by leveraging artificial intelligence (AI) systems, the disclosed techniques enable efficient and accurate modification of product assemblies while simultaneously generating real-time information associated with each modification. Such information may include a rendering of the modified assembly, a bill of materials (BOM), a specification sheet, a preferred list of components, and data reflecting component cost, availability, and placement. Real-time graphical displays of various metrics and attributes allow for continuous evaluation and refinement of the modified assembly based on design parameters such as performance or cost. The use of AI improves the quality and accuracy of results, reduces the likelihood of manual errors, and enhances processing efficiency by automating complex update operations. In contrast to traditional non-AI techniques, which typically produce a single design output for each modification, the disclosed techniques can generate multiple candidate variations in response to a single modification input. Such generative capability allows for broader exploration of the design space—far beyond what could be feasibly achieved through manual methods—and supports optimization processes that converge on higher-quality and better-performing design solutions.

1. In some embodiments, a computer-implemented method for performing operations associated with modifying product assemblies comprises: receiving a request for modifying a rendered product assembly; performing, in response to the request, at least one modification to the rendered product assembly; concurrently displaying a modified product assembly that reflects the at least one modification to the rendered product assembly; and concurrently updating a graphic display of one or more attributes of one or more components of the modified product assembly to enable evaluation of an effect of the at least one modification to the rendered product assembly.

2. The computer-implemented method of clause 1, further comprising: concurrently displaying information about one or more components associated with the at least one modification to the rendered product assembly.

3. The computer-implemented method of any of clauses 1-2, further comprising: updating in real-time at least one of the modified product assembly or the information about the one or more components of the modified product assembly to reflect additional modifications performed to the rendered product assembly.

4. The computer-implemented method of any of clauses 1-3, wherein concurrently displaying information about the one or more components of the modified product assembly comprises updating in real-time a display of at least one attribute of at least one component of the modified product assembly.

5. The computer-implemented method of any of clauses 1-4, wherein the at least one attribute comprises at least one of a location coordinate or a size of the at least one component of the modified product assembly.

6. The computer-implemented method of any of clauses 1-5, wherein concurrently displaying information about the one or more components of the modified product assembly comprises updating at least one of a location information, an orientation information, or a size information of at least one component of the modified product assembly.

7. The computer-implemented method of any of clauses 1-6, wherein the request for modifying the rendered product assembly is a multimodal modification request, and wherein performing the at least one modification comprises an AI system performing the at least one modification based on the multimodal modification request.

8. The computer-implemented method of any of clauses 1-7, wherein the multimodal modification request comprises at least one of an image, a hand-drawn sketch, a segment of text, an audio clip, or a video clip, and wherein performing the at least one modification to the rendered product assembly is in response to an action performed on the at least one of the image, the hand-drawn sketch, the segment of text, the audio clip, or the video clip.

9. The computer-implemented method of any of clauses 1-8, wherein the action comprises modifying the hand-drawn sketch by use of at least one of a writing instrument or a mouse.

10. The computer-implemented method of any of clauses 1-9, wherein the action comprises editing the segment of text.

11. In some embodiments, one or more non-transitory computer readable media store instructions that, when executed by one or more processors, cause the one or more processors to perform operations associated with modifying product assemblies, the operations comprising: receiving a request for modifying a rendered product assembly; performing, in response to the request, at least one modification to the rendered product assembly; concurrently displaying a modified product assembly that reflects the at least one modification to the rendered product assembly; and concurrently updating a graphic display of one or more attributes of one or more components of the modified product assembly to enable evaluation of an effect of the at least one modification to the rendered product assembly.

12. The one or more non-transitory computer readable media of clause 11, wherein the operations further comprise: concurrently displaying the rendered product assembly and the modified product assembly to enable evaluation of an effect of the at least one modification to the rendered product assembly upon the modified product assembly.

13. The one or more non-transitory computer readable media of any of clauses 11-12, wherein the operations further comprise: concurrently updating a graphic display of one or more attributes of one or more components of the modified product assembly to enable evaluation of an effect of the at least one modification to the rendered product assembly.

14. The one or more non-transitory computer readable media of any of clauses 11-13, wherein the one or more attributes comprise at least one of a location coordinate, a size, a price, or an availability.

15. The one or more non-transitory computer readable media of any of clauses 11-14, wherein the operations further comprise: concurrently displaying a bill of materials (BOM) of the modified product assembly.

16. The one or more non-transitory computer readable media of any of clauses 11-15, wherein the operations further comprise: updating the BOM in concurrence with additional modifications of the rendered product assembly.

17. The one or more non-transitory computer readable media of any of clauses 11-16, wherein the rendered product assembly is one of an existing product assembly or a proposed product assembly generated by an AI system.

18. The one or more non-transitory computer readable media of any of clauses 11-17, wherein the operations further comprise: concurrently displaying information about one or more components associated with the proposed product assembly that is generated by the AI system.

19. The one or more non-transitory computer readable media of any of clauses 11-18, wherein the request for modifying the rendered product assembly is based on at least one of the proposed product assembly or the information about the one or more components associated with the proposed product assembly.

20. In some embodiments, a computer system comprises one or more memories that include instructions, and one or more processors that are coupled to the one or more memories and that, when executing the instructions, are configured to perform the operations of: receiving a request for modifying a rendered product assembly; performing, in response to the request, at least one modification to the rendered product assembly; concurrently displaying a modified product assembly that reflects the at least one modification to the rendered product assembly, and concurrently updating a graphic display of one or more attributes of one or more components of the modified product assembly to enable evaluation of an effect of the at least one modification to the rendered product assembly.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing operations associated with modifying product assemblies, the computer-implemented method comprising:
receiving a request for modifying a rendered product assembly;
performing, in response to the request, at least one modification to the rendered product assembly;
concurrently displaying a modified product assembly that reflects the at least one modification to the rendered product assembly; and
concurrently updating a graphic display of one or more attributes of one or more components of the modified product assembly to enable evaluation of an effect of the at least one modification to the rendered product assembly.

2. The computer-implemented method of claim 1, further comprising:
concurrently displaying information about one or more components associated with the at least one modification to the rendered product assembly.

3. The computer-implemented method of claim 2, further comprising:
updating in real-time at least one of the modified product assembly or the information about the one or more components of the modified product assembly to reflect additional modifications performed to the rendered product assembly.

4. The computer-implemented method of claim 2, wherein concurrently displaying information about the one or more components of the modified product assembly comprises updating in real-time a display of at least one attribute of at least one component of the modified product assembly.

5. The computer-implemented method of claim 4, wherein the at least one attribute comprises at least one of a location coordinate or a size of the at least one component of the modified product assembly.

6. The computer-implemented method of claim 2, wherein concurrently displaying information about the one or more components of the modified product assembly comprises updating at least one of a location information, an orientation information, or a size information of at least one component of the modified product assembly.

7. The computer-implemented method of claim 1, wherein the request for modifying the rendered product assembly is a multimodal modification request, and wherein performing the at least one modification comprises an AI system performing the at least one modification based on the multimodal modification request.

8. The computer-implemented method of claim 7, wherein the multimodal modification request comprises at least one of an image, a hand-drawn sketch, a segment of text, an audio clip, or a video clip, and wherein performing the at least one modification to the rendered product assembly is in response to an action performed on the at least one of the image, the hand-drawn sketch, the segment of text, the audio clip, or the video clip.

9. The computer-implemented method of claim 8, wherein the action comprises modifying the hand-drawn sketch by use of at least one of a writing instrument or a mouse.

10. The computer-implemented method of claim 8, wherein the action comprises editing the segment of text.

11. One or more non-transitory computer readable media storing instructions that, when executed by one or more processors, cause the one or more processors to perform operations associated with modifying product assemblies, the operations comprising:
receiving a request for modifying a rendered product assembly;
performing, in response to the request, at least one modification to the rendered product assembly;
concurrently displaying a modified product assembly that reflects the at least one modification to the rendered product assembly; and
concurrently updating a graphic display of one or more attributes of one or more components of the modified product assembly to enable evaluation of an effect of the at least one modification to the rendered product assembly.

12. The one or more non-transitory computer readable media of claim 11, wherein the operations further comprise:
concurrently displaying the rendered product assembly and the modified product assembly to enable evaluation of an effect of the at least one modification to the rendered product assembly upon the modified product assembly.

13. The one or more non-transitory computer readable media of claim 11, wherein the operations further comprise:
concurrently updating a graphic display of one or more attributes of one or more components of the modified product assembly to enable evaluation of an effect of the at least one modification to the rendered product assembly.

14. The one or more non-transitory computer readable media of claim 13, wherein the one or more attributes comprise at least one of a location coordinate, a size, a price, or an availability.

15. The one or more non-transitory computer readable media of claim 11, wherein the operations further comprise:
concurrently displaying a bill of materials (BOM) of the modified product assembly.

16. The one or more non-transitory computer readable media of claim 15, wherein the operations further comprise:
updating the BOM in concurrence with additional modifications of the rendered product assembly.

17. The one or more non-transitory computer readable media of claim 11, wherein the rendered product assembly is one of an existing product assembly or a proposed product assembly generated by an AI system.

18. The one or more non-transitory computer readable media of claim 17, wherein the operations further comprise:
concurrently displaying information about one or more components associated with the proposed product assembly that is generated by the AI system.

19. The one or more non-transitory computer readable media of claim 18, wherein the request for modifying the rendered product assembly is based on at least one of the proposed product assembly or the information about the one or more components associated with the proposed product assembly.

20. A computer system, comprising:
one or more memories that include instructions; and
one or more processors that are coupled to the one or more memories and, when executing the instructions, are configured to perform the operations of:
receiving a request for modifying a rendered product assembly;
performing, in response to the request, at least one modification to the rendered product assembly;
concurrently displaying a modified product assembly that reflects the at least one modification to the rendered product assembly; and
concurrently updating a graphic display of one or more attributes of one or more components of the modified product assembly to enable evaluation of an effect of the at least one modification to the rendered product assembly.
